(19) United States
(12) Patent Application Publication
(10) Pub. No.: US 2008/0094477 A1
(43) Pub. Date: Apr. 24, 2008

(54) Webcam with a wire control device

(75) Inventor: Chao-Han Chang, Taipei (TW)

Correspondence Address: BACON & THOMAS, PLLC, 625 SLATERS LANE, FOURTH FLOOR, ALEXANDRIA, VA, 22314, US

(73) Assignee: PCHOME ONLINE INC., Taipei (TW)

(21) Appl. No.: 11/703,083

(22) Filed: Feb. 7, 2007

(30) Foreign Application Priority Data
Oct. 20, 2006 (TW) 095218593

(51) Int. Cl. H04N 5/225

(52) U.S. Cl. 348/207.11; 348/E05.024

(57) ABSTRACT

A webcam comprises: a main body, a wire control device, a control connecting line, and a connecting device. The main body comprises a digital image processing device to produce a digital image. The control connecting line is used to connect the wire control device and the main body.

The wire control device has at least one operation button; the operation button could be a shooting button, a network visual controlling button, or an image adjusting button. The wire control device is used to let the user operate the button direction and control the digital image processing with the computer.

### BACKGROUND OF THE INVENTION

1. Field of the Invention

The present invention relates to a webcam, and more particularly, to a webcam with a wire control device.

2. Description of the Related Art

Internet products are becoming more and more common nowadays, and the webcam becomes a required electric device for many users. However, in using the webcam, the button of the main body must be pressed directly when user wants to execute shooting or other function. Therefore, it is not convenient to the users. If the user is not careful, he might shock or move the lens by touching the main body when the webcam is shooting. It might shoot a blur film or loose the focus of the camera.

On the other hand, if the user wants to execute another function or image adjustment, like brightness, the user usually uses the software of the computer to control the webcam. It would bother with the user who is not conversant of the computer controls.

Therefore, it is desirable to provide a webcam that prevents the aforementioned problems.

### SUMMARY OF THE INVENTION

An objective of the present invention is to provide a webcam that lets the user shoot a digital image which is produced by a webcam in a far distance.

The webcam of the present invention comprises a main body, a wire control device, a control connecting line, and a connecting device. The main body comprises a digital image process device to product a digital image. The control connecting line is used to connect the wire control device and the main body.

The wire control device has at least one operation button, the operation button comprises a shooting button, a network visual controlling button, or an image adjusting button. The wire control device is used to let the user operate the operation button and control the digital image process of a computer.

The connecting device is used to connect digital image process device and the computer, and transfer the digital image from the digital image processing device to the computer. The connecting device may be a USB connection or other connection.

Other objects, advantages, and novel features of the invention will become more apparent from the following detailed description when taken in conjunction with the accompanying drawings.

### BRIEF DESCRIPTION OF THE DRAWINGS

FIG. 1 is a functional block diagram of a webcam according to the present invention.

FIG. 2 is a schematic drawing of a webcam's first embodiment of the present invention.

FIG. 3 is a schematic drawing of a webcam's second embodiment of the present invention.

FIG. 4 is a schematic drawing of a webcam's third embodiment of the present invention.

FIG. 5 is a schematic drawing of a webcam's fourth embodiment of the present invention.

### DETAILED DESCRIPTION OF THE PREFERRED EMBODIMENT

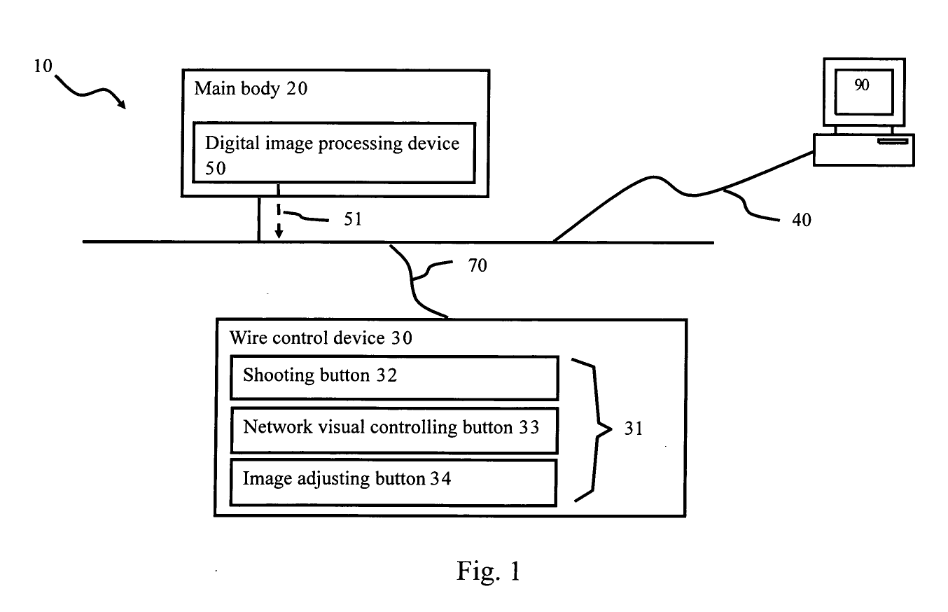

Please refer to FIG. 1. FIG. 1 is a functional block diagram of a webcam 10 according to the present invention.

A webcam 10 comprises a main body 20, a wire control device 30, a control connecting line 70, and a connecting device 40. The main body 20 comprises a digital image process device 50 to product a digital image 51. The digital image process device 50 may be produced by CCD or CMOS element or other sensitive element. It usually comprises some control circuits. Further description is not presented because the digital image process device 50 is a known technology.

The digital image processing device 50 is used to shoot a film or take a picture, wherein the digital image process device 50 will transfer the digital image 51 to the computer 90 by the connecting device 40 and the user could execute further processes. The connecting device 40 which is a soft wire with connection or some necessary control circuits is usually used to connect the digital image process device 50 and the computer 90 and transfer the digital image from the digital image processing device 50 to the computer 90. The connecting device 40 may be a USB connection or other connections, the present invention is not limited to the aforementioned embodiment.

The wire control device 30 comprises at least one operation button 31 to control the production of the digital image 51. The user can operate the operation button 31 directly without touching the body of the digital image processing device 50. The operation button 31 comprises a shooting button 32, a network visual controlling button 33, or an image adjusting button 34. The operation buttons on the wire control device 30 could increase or decrease accordingly by demand. For example, it can capture a digital image from the digital image processing device 50 and display on the screen of the computer 90 after the user pressing the shooting button 32. When the user presses the network visual controlling button 33, it will command the computer 90 to execute a network visual function instantly. Like Skype or other network visual phone, the user can talk to each other accompanied with images. The image adjusting button 34 is used to adjust brightness or contract of the digital image to obtain the clearer digital image. Using the wire control device 30, the user does not need to set the visual of the digital image by the software of the computer 90 therefore it is more convenient for the user.

Basically, there are two main processes to control the digital image 51 by the operation button 31 of the wire control device 30. The first way is transfer a control signal to the digital image process device 50 directly. After processing the digital image 51, the digital image processing device 50 transfers the digital image 51 to the computer 90. The second way is transfer the control signal, which is triggered by the operation button 31, to the computer 90 and processes the digital image 51 by the image software of the computer 90.

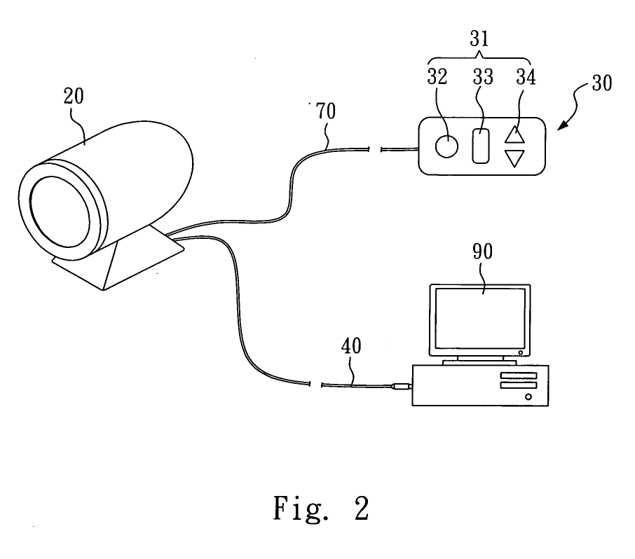

The appearance structure of the webcam 10 in the present invention can be of many diverse structures. There are four embodiments listed, please refer to FIG. 2 to FIG. 5. FIG. 2 to FIG. 5 are schematic drawings of a webcam to different embodiments of the present invention.

As shown in FIG. 2, FIG. 2 is a schematic drawing of the webcam's first embodiment of the present invention. The wire control device 30 connects with the main body 20 by a control connecting line 70. The user operates the shooting button 32, the network visual controlling button 33, or the image adjusting button 34 of the wire control device 30. Then the digital image processing device 50 connects with the computer 90 by a connecting device 40, the computer 90 might receive the related digital image through the connecting device 40 and executes further digital image processing according to the user's operation.

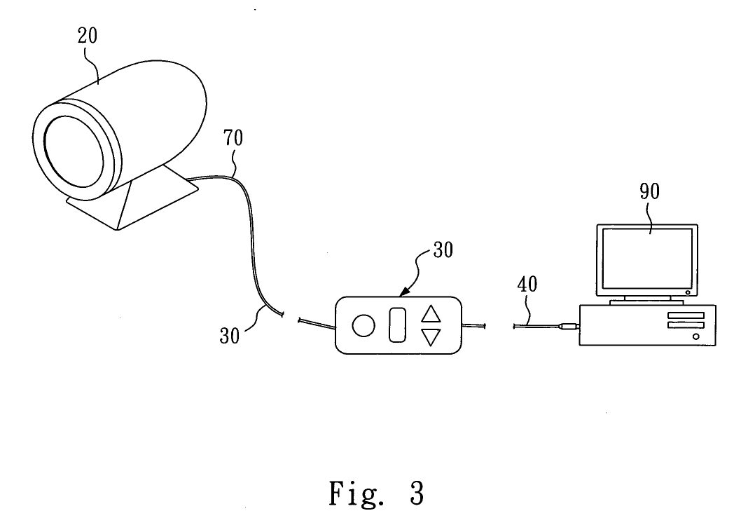

The connecting way of the wire control device 30 and the connecting device 40 can be FIG. 3. Please refer to FIG. 3. FIG. 3 is a schematic drawing of the webcam's second embodiment of the present invention. The control connecting line 70 and the connecting device 40 can be used in the same line from the appearance, the wire control device 30 is located between the main body 20 and the computer 90. Take note that, according to the electric circuit design, the control connecting line 70 and the connecting device 40 might be in the same line, or the different lines. As described above, the present embodiment can be in the same line from the appearance.

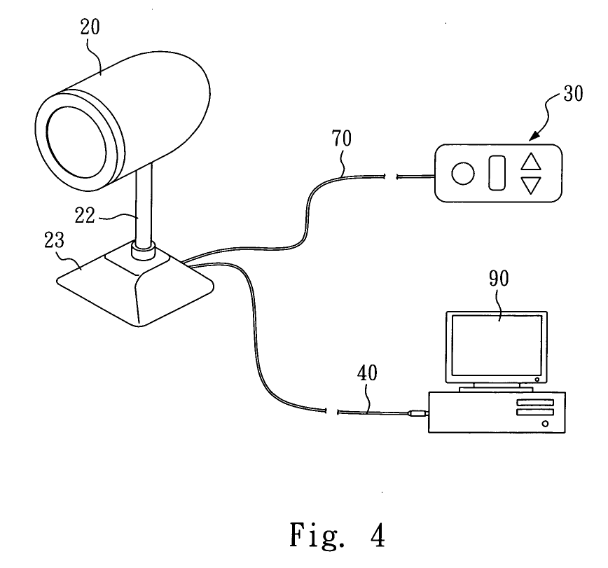

Please refer to FIG. 4. FIG. 4 is a schematic drawing of the webcam's third embodiment of the present invention. The main body 20 comprises a long pipe 22 and a base 23. The control connecting line 70 connects with the long pipe 22 and the connecting device 40 connects with the base 23.

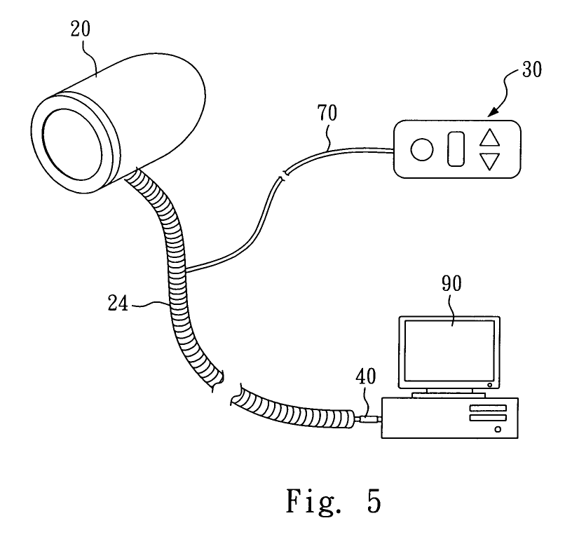

Please refer to FIG. 5. FIG. 5 is a schematic drawing of the webcam's fourth embodiment of the present invention. The structure of the webcam 10 can comprise without the base 23. The main body 20 can connect with the computer 90 by the connecting device 40 of a screw pipe 24, and the control connecting line 70 connects with the screw pipe 24.

The connecting location between the wire control device 30 and the connecting device 40 with the digital image processing device 50 is not only the structure shown in FIG. 2 to FIG. 5. It might change the connecting location according to different designs.

Although the present invention has been explained in relation to its preferred embodiment, it is to be understood that many other possible modifications and variations can be made without departing from the spirit and scope of the invention as hereinafter claimed.

What is claimed is:

1. A webcam electrically connected with a computer comprising:
a main body comprising a digital image processing device to produce a digital image;
a wire control device comprising at least one operation button to control the function of digital image process;
a control connecting line connecting with the main body and the wire control device; and
a connecting device connecting with the main body and the computer to transfer the digital image to the computer.

2. The webcam as claimed in claim 1, wherein the operation button comprising a shooting button then a user could capture the digital image by executing the shooting button.

3. The webcam as claimed in claim 2, wherein the operation button comprising a network visual controlling button.

4. The webcam as claimed in claim 2, wherein the operation button comprising an image adjusting button.

5. The webcam as claimed in claim 2, wherein the main body comprising a long pipe, the control connecting line is connected with the long pipe.

6. The webcam as claimed in claim 5, wherein main body comprising a base, the base is connecting with the long pipe.

7. The webcam as claimed in claim 2, wherein the control connecting line and the connecting device are in the same line from the view of the appearance.

8. The webcam as claimed in claim 2, wherein the main body comprising a screw pipe, the control connecting line is connected with the screw pipe.

9. The webcam as claimed in claim 1, wherein the operation button comprising a network visual controlling button.

10. The webcam as claimed in claim 1, wherein the operation button comprising an image adjusting button.

11. The webcam as claimed in claim 1, wherein the main body comprising a long pipe, the control connecting line is connected with the long pipe.

12. The webcam as claimed in claim 11, wherein main body comprising a base, the base is connecting with the long pipe.

13. The webcam as claimed in claim 1, wherein the control connecting line and the connecting device are in the same line from the appearance.

14. The webcam as claimed in claim 1, wherein the main body comprising a screw pipe, the control connecting line is connected with the screw pipe.
